(19) United States
(12) Patent Application Publication
(10) Pub. No.: US 2024/0036320 A1
(43) Pub. Date: Feb. 1, 2024

(54) IMAGE DISPLAY DEVICE AND OPTICAL UNIT

(71) Applicant: SEIKO EPSON CORPORATION, Tokyo (JP)

(72) Inventor: Tokito YAMAGUCHI, Azumino-shi (JP)

(73) Assignee: SEIKO EPSON CORPORATION, Tokyo (JP)

(21) Appl. No.: 18/227,704

(22) Filed: Jul. 28, 2023

(30) Foreign Application Priority Data
Jul. 29, 2022 (JP) 2022-122356

(51) Int. Cl. G02B 27/01; G02B 7/02

(52) U.S. Cl. CPC G02B 27/0172; G02B 7/021; G02B 2027/0178

(57) ABSTRACT

An image display device according to a specific aspect includes: a first image element, a first optical member disposed on a light emission side of the image element, a second optical member including an incident surface disposed on the light emission side of the first optical member, a reflection surface configured to bend an optical axis, and a concaved emitting surface, and a barrel configured to accommodate the first optical member and hold the second optical member, wherein the emitting surface of the second optical member is exposed through an opening of the barrel, and an outer edge of the emitting surface is surrounded by an edge portion of the opening.

The present application is based on, and claims priority from JP Application Serial Number 2022-122356, filed Jul. 29, 2022, the disclosure of which is hereby incorporated by reference herein in its entirety.

### BACKGROUND

### 1. Technical Field

The present disclosure relates to an image display device and an optical unit that enable observation of a virtual image.

### 2. Related Art

There is an image display device including a display element that displays an image, an ocular prism that guides image light from the display element to an optical pupil and allows the outside world to be seen therethrough, and a housing that contains and holds the display element and part of the ocular prism, wherein a packing is provided so as to be in contact with the periphery of the ocular prism and the housing.

Image light is made incident on an end portion of an ocular prism in a device disclosed in JP-A-2009-157291. In an image display device of the type in which the image light is made incident on one surface of a combiner that enables the outside world to be seen, an optical path from an optical element on the upstream side of the combiner to the one surface of the combiner is exposed. Thus, the optical element needs to be protected.

### SUMMARY

An image display device according to an aspect of the present disclosure includes: an image element, a first optical member disposed on a light emission side of the image element, a second optical member including an incident surface disposed on the light emission side of the first optical member, a reflection surface configured to bend an optical axis, and an emitting surface, and a barrel configured to accommodate the first optical member and hold the second optical member, wherein the emitting surface of the second optical member is exposed through an opening of the barrel, and an outer edge of the emitting surface is surrounded by an edge portion of the opening.

### BRIEF DESCRIPTION OF THE DRAWINGS

FIG. 1 is an external perspective view illustrating a mounted state of an image display device according to an embodiment.

FIG. 2 is a side cross-sectional view illustrating an internal structure of a display device on one side.

FIG. 3 is a side cross-sectional view illustrating an optical structure of a display part in detail.

FIG. 4 is a perspective view illustrating a support structure of a display part.

FIG. 5 is a perspective view illustrating an outer shape of the display part.

FIG. 6 is a side cross-sectional view of a barrel and an optical member held by the barrel.

FIG. 7 is a rear view of a remaining portion as a result of removing a barrel cover and the like.

FIG. 8 is a perspective view illustrating the positional relationship between a guard and a prism mirror and the like.

FIG. 9 is a front view and a plan view illustrating how a combiner is fixed to the barrel.

FIG. 10 is a schematic view illustrating a front cross-sectional structure of a display device on one side.

### DESCRIPTION OF EXEMPLARY EMBODIMENTS

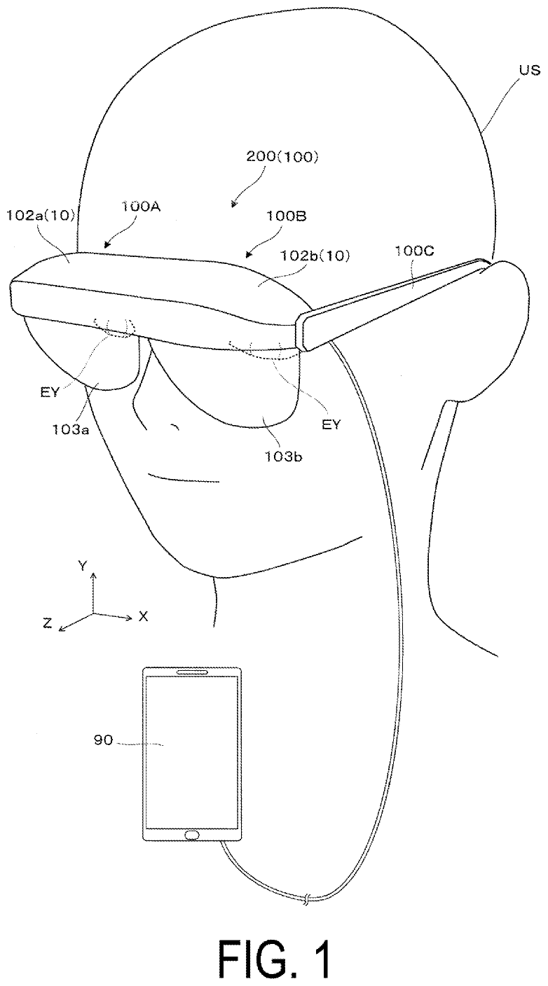

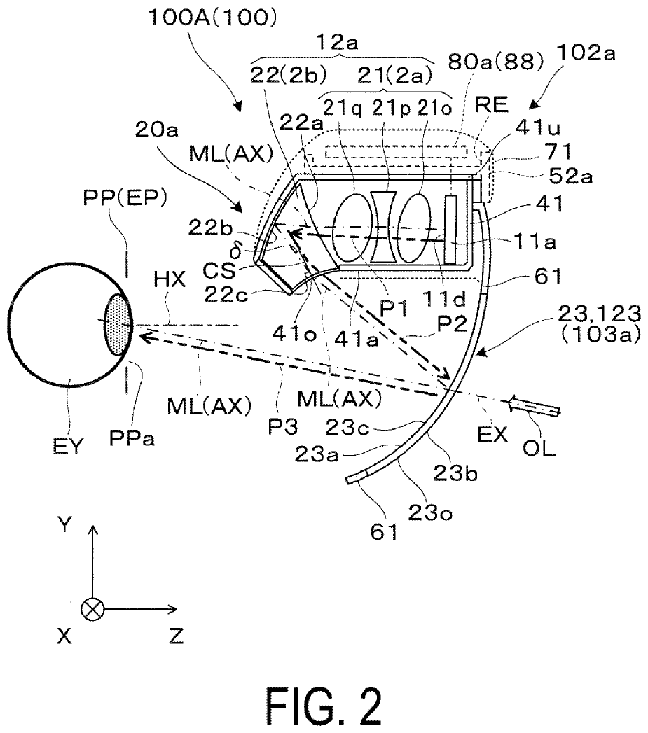

Next, an image display device according to an embodiment of the present disclosure will be described with reference to FIG. 1, FIG. 2, and other figures.

FIG. 1 is a diagram showing a mounted state of a head-mounted display (hereinafter, also referred to as “HMD”) 200, and the HMD 200 allows an observer or wearer US who is wearing the HMD 200 to be able to recognize an image as a virtual image. In FIG. 1 and the like, X, Y, and Z are an orthogonal coordinate system, a +X direction corresponds to a transverse direction in which the two eyes EY of the observer or wearer US who is wearing the HMD 200 or an image display device 100 are disposed, a +Y direction corresponds to an upward direction orthogonal to the transverse direction in which the two eyes EY of the wearer US are disposed, and a +Z direction corresponds to a direction to the front or a forward direction for the wearer US. The ±Y directions are parallel to the vertical axis or the vertical direction.

The HMD 200 includes a first display device 100A for the right eye, a second display device 100B for the left eye, a pair of temple type support devices 100C that support the display devices 100A and 100B, and a user terminal 90 that is an information terminal. The first display device 100A includes: a first display drive part 102a that is disposed at an upper portion thereof and independently functions as an image display device, and a first combiner 103a that has a spectacle lens shape and covers the front of the eye. The second display device 100B similarly includes: a second display drive part 102b that is disposed at an upper portion thereof and independently functions as an image display device, and a second combiner 103b that has a spectacle lens shape and covers the front of the eye. The support devices 100C are each a mounted member mounted to the head of the wearer US, and supports the upper end side of the pair of combiners 103a and 103b via the display drive parts 102a and 102b integrated in external view. The first display device 100A and the second display device 100B are optically the same or are inverted left and right, and hereinafter, the detailed description on the second display device 100B will be omitted.

FIG. 2 is a side cross-sectional view illustrating an internal structure of the first display device 100A. The first display device 100A includes a first image element 11a, a first display part 20a, and a first circuit member 80a. The first image element 11a is an image light generating device and is also referred to as a display element. The first display part 20a is an imaging optical system that forms a virtual image, and includes a projection lens 21, a prism mirror 22, and a see-through mirror 23 in an integrated state. In the first display part 20a, the projection lens 21 and the prism mirror 22 function as a first projection optical system 12a on which image light ML from the first image element 11a is incident, and the see-through mirror 23 functions as a partially transmissive mirror 123 that partially reflects the image light ML emitted from the first projection optical system 12a toward a pupil position PP or the eye EY. The first display part 20a includes the first projection optical system 12a and the first combiner 103a in an integrated state. The projection lens 21 constituting the first projection optical system 12a corresponds to a first optical member 2a disposed on the light emission side of the first image element 11a, and the prism mirror 22 corresponds to a second optical member 2b disposed on the light emission side of the first optical member 2a which is the projection lens 21. The first image element 11a, the projection lens 21, and the prism mirror 22 correspond to part of the first display drive part 102a illustrated in FIG. 1, and the see-through mirror 23 is disposed on the light emission side of the second optical member 2b and corresponds to the first combiner 103a illustrated in FIG. 1. The projection lens 21 and the prism mirror 22 constituting the first projection optical system 12a are fixed in a container-shaped barrel 41 in a mutually aligned state together with the first image element 11a.

The barrel 41 that supports the optical members 2a and 2b constituting the first projection optical system 12a is supported by a first frame 52a and is disposed on the lower side of the first frame 52a. The first frame 52a is covered by a cover 71, and the barrel 41 is also entirely covered by the cover 71. The first frame 52a is formed of a metal material. The barrel 41 and the cover 71 are formed of a light-shielding resin material, and one surface of the prism mirror 22 is exposed through an opening 410 of the barrel 41. The barrel 41 has a barrel cover 41u of the upper portion for example, in contact with the first frame 52a in a fitted manner, to be fixed in a state of being suspended from the first frame 52a. As a result, the first display part 20a is fixed in a state of being suspended from the first frame 52a via the barrel 41. The first frame 52a has, on the upper side, a recess RE for arranging the first circuit member 80a.

In the first display device 100A, the first image element 11a is a spontaneous light emission type image light generating device. The first image element 11a emits the image light ML to the first projection optical system 12a. The barrel 41 accommodates and supports the first image element 11a together with the optical elements constituting the first projection optical system 12a. The first image element 11a is, for example, an organic electroluminescence (EL) display, and forms a color still image or moving image on a two-dimensional display surface 11d. The first image element 11a is driven by the first circuit member 80a, in particular, a display control device 88 to perform a display operation. The first image element 11a is not limited to the organic EL display, and can be replaced with a display device using inorganic EL, an organic LED, an LED array, a laser array, a quantum dot light emission element, or the like. The first image element 11a is not limited to the spontaneous light emission type image light generating device, may include an LCD or another light modulation element, and may form an image by illuminating the light modulation element with a light source such as a backlight. As the first image element 11a, a liquid crystal on silicon (LCOS) (LCoS is a registered trademark), a digital micro-mirror device, or the like may be used instead of the LCD. A device obtained by omitting the display control device 88 from the first display device 100A is also referred to as the image display device 100.

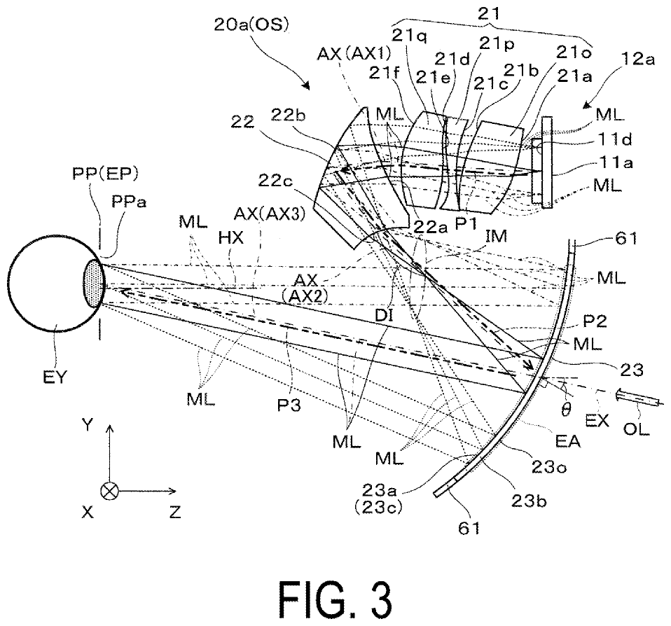

FIG. 3 is a side cross-sectional view illustrating an optical structure of the first display part 20a in detail. In the first display part 20a, two reflection surfaces are included, and the optical path is bent by the see-through mirror 23 and the prism mirror 22. The first display part 20a is an off-axis optical system OS. The projection lens 21, the prism mirror 22, and the see-through mirror 23 are disposed to be non-axially symmetrical. In the first display part 20a, the optical elements 21, 22, and 23 are arranged along an off-axis plane (that is, a reference plane) by bending an optical axis AX in the off-axis plane parallel to the Y-Z plane serving as the reference surface. Specifically, in the off-axis plane parallel to the Y-Z plane and corresponding to the paper plane, an optical path portion P1 from the projection lens 21 to an inner reflection surface 22b, an optical path portion P2 from the inner reflection surface 22b to the see-through mirror 23, and an optical path portion P3 from the see-through mirror 23 to the pupil position PP are bent in a Z shape in two stages. In accordance with this, an optical axis portion AX1 from the projection lens 21 to the inner reflection surface 22b, an optical axis portion AX2 from the inner reflection surface 22b to the see-through mirror 23, and an optical axis portion AX3 from the see-through mirror 23 to the pupil position PP are bent in a Z shape in two stages. In the see-through mirror 23, a normal line of a center portion intersecting with the optical axis AX forms an angle of about θ=40 to 50° with respect to the Z direction. In the first display part 20a, the optical elements 21, 22, and 23 constituting the first display device 100A are arranged so that height positions thereof are changed in the longitudinal direction, and an increase in a transverse width of the first display device 100A can be prevented. Furthermore, the optical path portions P1 to P3 or the optical axis portions AX1 to AX3 bent in a Z shape in two stages due to the bending of the optical paths as a result of the reflection on the prism mirror 22 and the like, and the optical path portions P1 and P3 or the optical axis portions AX1 and AX3 are relatively close to horizontal. Thus, the first display part can be downsized in the upward and downward direction as well as the forward and backward direction. An inclination angle θ of the center portion of the see-through mirror 23 is ° to 50°, meaning that the optical path portion P2 is inclined by 70° to 90° with respect to the Z axis when the inclination of the optical path portion P3 corresponding to the line of sight is constant. Thus, thickness of the image display device 100 in the Z direction can be easily reduced.

In the first display part 20a, the optical path portion P1 from the projection lens 21 to the reflection surface 22b extends upward slightly obliquely or in a direction close to being parallel to the Z direction, toward the backward side from the viewpoint. The optical path portion P2 from the reflection surface 22b to the see-through mirror 23 extends downward obliquely toward the front side. The optical path portion P2 is inclined more than the optical path portion P1 relative to the horizontal direction (X-Z plane). The optical path portion P3 from the see-through mirror 23 to the pupil position PP extends in the upward direction slightly obliquely or a direction close to being parallel to the Z direction toward the backward side. In the illustrated example, a portion of the optical axis AX corresponding to the optical path portion P3 is about −10°, where a downward orientation in the +Z direction is negative. Thus, the partially transmissive mirror 123 reflects the image light ML, with the optical axis AX or the optical path portion P3 directed upward by a predetermined angle, that is, upward by about 10°. As a result, an emission optical axis EX that is an extension of the optical axis portion AX3 corresponding to the optical path portion P3 is inclined downward by about 10° with respect to a center axis HX parallel to the +Z direction on the front side and extends. This is because a line of sight of a human being is stable in a slightly lowered eye state in which the line of sight is inclined downward by approximately 10° with respect to a horizontal direction. The center axis HX that extends in the horizontal direction with respect to the pupil position PP assumes a case in which the wearer US wearing the first display device 100A relaxes in an upright posture and faces the front and gazes at the horizontal direction or the horizontal line.

In the first display part 20a, the projection lens 21 includes a first lens 21o, a second lens 21p, and a third lens 21q. The projection lens 21 receives the image light ML emitted from the first image element 11a and makes the image light ML incident on the prism mirror 22. The projection lens 21 focuses the image light ML emitted from the first image element 11a into a state close to a parallel luminous flux. The first lens 21o, the second lens 21p, and the third lens 21q, constituting the projection lens 21, respectively include an incident surface 21a and an emitting surface 21b, an incident surface 21c and an emitting surface 21d, and an incident surface 21e and an emitting surface 21f that are freely-curved surfaces or aspherical surfaces The optical surfaces 21a, 21b, 21c, 21d, 21e, and 21f are asymmetrical about the optical axis AX relative to the longitudinal direction, which is parallel to the Y-Z plane and crosses the optical axis AX, and are symmetrical about the optical axis AX relative to the transverse direction or the X direction. The first lens 21o, the second lens 21p, and the third lens 21q are formed of resin for example, but may also be formed of glass. An antireflection film can be formed on the optical surfaces of the first lens 21o, the second lens 21p, and the third lens 21q constituting the projection lens 21.

The prism mirror 22 is an optical member having a refractive and reflection function that is a function of combining a mirror and a lens, and reflects the image light ML from the projection lens 21 while refracting it. The prism mirror 22 includes the incident surface 22a disposed on the light emission side of the first optical member, the reflection surface 22b for bending the optical axis AX, and the emitting surface 22c disposed in a direction opposite to the reflection surface 22b and symmetrical to the incident surface 22a. The prism mirror 22 emits the image light ML incident from the front where the projection lens 21 is disposed, such that it is bent in a direction inclined downward with respect to a direction in which an incident direction is reversed (a direction of the light source seen from the prism mirror 22). The incident surface 22a, the reflection surface 22b, and the emitting surface 22c, which are optical surfaces forming the prism mirror 22, are asymmetrical about the optical axis AX relative to the longitudinal direction, which is parallel to the Y-Z plane and crosses the optical axis AX, and are symmetrical about the optical axis AX relative to the transverse direction or the X direction. The optical surface of the prism mirror 22, that is, the incident surface 22a, the reflection surface 22b, and the emitting surface 22c are, for example, freely-curved surfaces. The incident surface 22a, the reflection surface 22b, and the emitting surface 22c are not limited to freely-curved surfaces, and may be aspherical surfaces. The prism mirror 22 may be formed of, for example, a resin, but may also be formed of glass. The reflection surface 22b is not limited to one that reflects the image light ML by total reflection, and may be a reflection surface formed of a metal film or a dielectric multilayer film. In this case, for example, a reflection film formed of a single layer film or multilayer film formed of a metal such as Al or Ag is formed on the reflection surface 22b by vapor deposition or the like, or a sheet-shaped reflection film formed of a metal is affixed thereto. Although detailed illustration is omitted, an antireflection film can be formed on the incident surface 22a and the emitting surface 22c.

The emitting surface 22c of the prism mirror 22 is concave as a whole, is concave on an off-axis plane parallel to the Y-Z plane and through which the optical axis portions AX1 to AX3 pass, that is, on the paper plane, and is also concave in a cross section CS (see FIG. 2) perpendicular to the Y-Z plane and passing through the center of the emitting surface 22c. That is, the emitting surface 22c is a concave surface having asymmetry in the off-axis plane, and is a concave surface having symmetry in the cross section CS perpendicular to the off-axis plane. The emitting surface 22c of the prism mirror 22 is exposed through the opening 410 of the barrel 41, but by thus having a concave shape, is less likely to be in contact with an external object, and thus is less likely to be damaged. The emitting surface 22c of the prism mirror 22 is disposed near the relatively small intermediate image IM and is disposed at a position where the luminous flux cross-section of the image light ML is narrowed, and thus can have a relatively small area. Also with the area of the emitting surface 22c of the prism mirror 22 thus set to be relatively small, a risk of the emitting surface 22c being damaged can be reduced. The intermediate image IM is formed closer to emitting surface 22c of the prism mirror 22 than to the reflection surface 23c of the see-through mirror 23. A distance DI from the reflection surface 23c to the intermediate image IM is set to L2×(½) or less, more preferably L2×(⅖) or less, where L2 is the length of the optical path portion P2 or the optical axis portion AX2.

The emitting surface 22c of the prism mirror 22 is substantially parallel to the optical axis portion AX2 on the inner surface side of the intersecting position of the optical axis portion AX2. Thus, the amount of refraction on the emitting surface 22c can be reduced, and an increase in aberration can be suppressed. An inclination δ of the emitting surface 22c on the inner surface side of the intersecting position of the optical axis portion AX2 corresponds to an angle formed by the optical axis portion AX2 and the cross section CS perpendicular to the emitting surface 22c at the intersecting position of the optical axis portion AX2, and is, for example, ° or less.

The see-through mirror 23, that is, the first combiner 103a is a curved plate-shaped reflective optical member that functions as a concave surface mirror, and partially reflects the image light ML from the prism mirror 22, and partially transmits outside light OL. The see-through mirror 23 reflects the image light ML from the prism mirror 22 toward a pupil position PP. The see-through mirror 23 has a reflection surface 23c and an outer side surface 23o.

The see-through mirror 23 is a concave mirror that covers the pupil position PP at which the eye EY or the pupil is disposed, has a concave shape toward the pupil position PP, and has a convex shape toward the outside. The pupil position PP or its opening PPa is referred to as eye point or eye box. The pupil position PP or the opening PPa corresponds to an emission pupil EP on the emission side of the first display part 20a. The see-through mirror 23 is a collimator, and converges the main rays of the image light ML spread after the imaging in the vicinity of the emission side of the prism mirror 22 of the first projection optical system 12a, which are the main rays of the image light ML emitted from each of points on the display surface 11d, at the pupil position PP. The see-through mirror 23 serves as a concave mirror to enable magnified view of the intermediate image IM formed on the first image element 11a as the image light generating device and re-imaged by the first projection optical system 12a. More specifically, the see-through mirror 23 functions in the same manner as a field lens, and causes the image light ML from each point of the intermediate image IM formed behind the emitting surface 22c of the prism mirror 22 to be incident on the pupil position PP in a collimated state so as to be collected as a whole. The see-through mirror 23 is disposed between the intermediate image IM and the pupil position PP, and thus needs to spread to a size that is equal to or larger than the effective area EA corresponding to the angle of view. Here, the angle of view is a combination of viewing angles on the upper, lower, left, and right sides with respect to the optical axis AX extending in the forward direction of the eye, and is set to about 45° diagonally in a specific example. In the see-through mirror 23, an outer region extending to the outside of the effective area EA does not directly affect image formation, and thus can have any surface shape. Still, for ensuring a spectacle lens shape, preferably, the curvature of the outer region is the same as the curvature of the surface shape of the outer edge of the effective area EA, or the curvature of the outer region continuously changes from the outer edge.

The see-through mirror 23 is a semi-transmissive mirror plate having a structure in which a transmissive reflection film 23a is formed on a back surface of a plate-shaped body 23b. The reflection surface 23c of the see-through mirror 23 is asymmetrical about the optical axis AX relative to the longitudinal direction, which is parallel to the Y-Z plane and crosses the optical axis AX, and is symmetrical about the optical axis AX relative to the transverse direction or the X direction. The reflection surface 23c of the see-through mirror 23 is, for example, a freely-curved surface. The reflection surface 23c is not limited to a freely-curved surface, and may be an aspherical surface. The reflection surface 23c needs to spread to a size that is equal to or larger than the effective area EA. When the reflection surface 23c is formed in the outer region wider than the effective area EA, a difference in visibility is less likely to occur between an external image from behind the effective area EA and an external image from behind the outer region.

when the image light ML is reflected, part of the light is reflected by the reflection surface 23c of the see-through mirror 23. Thus, because outside light OL passes through the see-through mirror 23, see-through view of the outside is enabled, and a virtual image can be superimposed on an outside image. At this time, when the plate-shaped body 23b has a thickness of less than or equal to approximately a few millimeters, a change in magnification of the outside image can be curbed to be small. A reflectance of the reflection surface 23c with respect to the image light ML and the outside light OL is set to 10% or more and 50% or less in a range (corresponding to an effective area EA) of an incident angle of the assumed image light ML from the viewpoint of ensuring a brightness of the image light ML and facilitating observation of the external image by see-through. The plate-shaped body 23b which is a base material of the see-through mirror 23 is formed of, for example, a resin, and may also be formed of glass. The plate-shaped body 23b is formed of the same material as the support plate 61 that supports the plate-shaped body 23b from the surrounding thereof, and has the same thickness as the support plate 61. The transmissive reflection film 23a is formed of, for example, a dielectric multilayer film configured of a plurality of dielectric layers having an adjusted film thickness. The transmissive reflection film 23a may be a single-layer film or a multilayer film of a metal such as Al or Ag of which a film thickness has been adjusted. The transmissive reflection film 23a may be formed by laminating using deposition, for example, and may also be formed by affixing a sheet-shaped reflection film. An antireflection film is formed on an outer surface 23o of the plate-shaped body 23b.

In describing the optical path, the image light ML from the first image element 11a is emitted from the projection lens 21 in a state in which it is incident on the projection lens 21 and is substantially collimated. The image light ML that has passed through the projection lens 21 is incident on the prism mirror 22, passes through the incident surface 22a while being refracted by it, is reflected by the reflection surface 22b with a high reflectance close to 100%, and is refracted again by the emitting surface 22c. After the tentative intermediate image IM is formed, the image light ML from the prism mirror 22 is incident on the see-through mirror 23 and is reflected by the reflection surface 23c with a reflectance of about 50% or less. The image light ML reflected by the see-through mirror 23 is incident on the pupil position PP at which the eye EY or pupil of the wearer US is placed. The outside light OL that has passed through the see-through mirror 23 and the support plate 61 therearound is also incident on the pupil position PP. In other words, the wearer US wearing the first display device 100A can observe a virtual image of the image light ML in a state in which it overlaps the external image.

The display control device 88 illustrated in FIG. 2 is a display control circuit, and controls a display operation of the first display element 11a by outputting a drive signal corresponding to an image to the first display element 11a. The display control device 88 includes, for example, an IF circuit, a signal processing circuit, and the like, and causes a two-dimensional image display to be performed on the first display element 11a according to image data or an image signal received from the outside. The display control device 88 may include a main substrate that controls a first display device 100A and a second display device 100B. The main substrate may have, for example, an interface function that communicates with the user terminal 90 illustrated in FIG. 1 and performs signal conversion on a signal received from the user terminal 90, and an integrated function that links between the display operation of the first display device 100A and the display operation of the second display device 100B. The HMD 200 or the image display device 100 that does not include the display control device 88 or the user terminal 90 is also a virtual image display device.

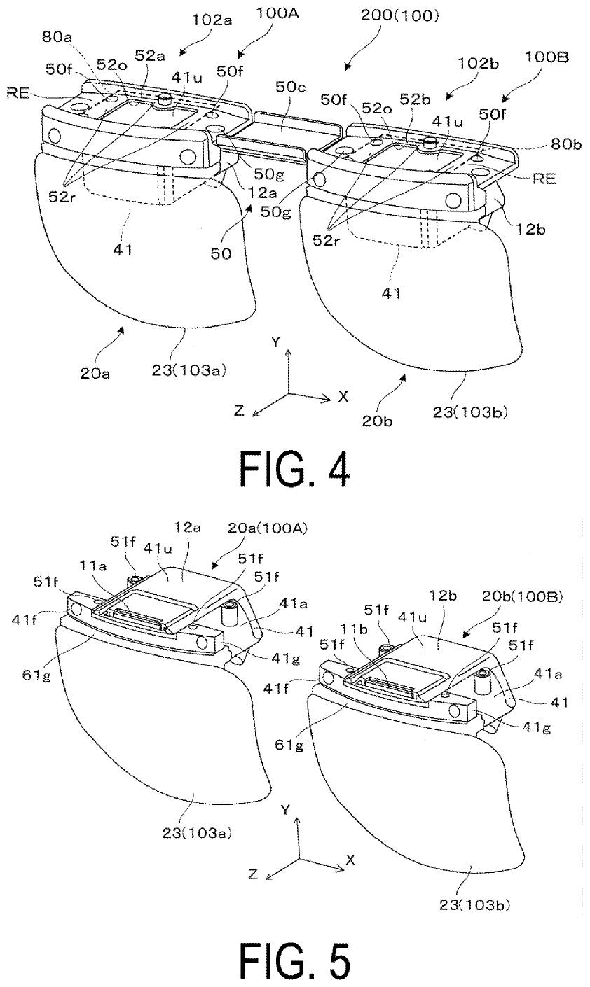

With reference to FIG. 4, a support structure incorporated in the display drive parts 102a and 102b of the HMD 200 will be described. In the first display device 100A, the first frame 52a is fixed to the barrel 41 of the first display part 20a using a fastener 50f such as a screw, and supports the first display part 20a in a suspended manner. A rectangular opening 52o is formed in the first frame 52a, and part of a periphery 52r of the rectangular opening 52o comes into close contact with the barrel 41 or the barrel cover 41u of the first display part 20a. The first circuit member 80a is disposed in the recess RE on the first frame 52a. The first frame 52a is formed of, for example, magnesium alloy. In the second display device 100B, a second frame 52b is fixed to the barrel 41 of a second display part 20b using the fastener 50f such as a screw, and supports the second display part 20b in a suspended manner. The rectangular opening 52o is formed in the second frame 52b, and part of the periphery 52r of the rectangular opening 52o comes into close contact with the barrel 41 or the barrel cover 41u of the second display part 20b. A second circuit member 80b is disposed in the recess RE on the second frame 52b. The second frame 52b is formed of, for example, magnesium alloy.

In addition to the first frame 52a and the second frame 52b, a support device 50 includes a joint 50c that couples the first frame 52a and the second frame 52b to relatively fix them. The joint 50c is a member made of metal such as magnesium alloy, and is coupled to one end portion of the first frame 52a using a fastener 50g or the like, and is coupled to the other end portion of the second frame 52b using the fastener 50g or the like. The first frame 52a to which the first display part 20a is attached and the second frame 52b to which the second display part 20b is attached are fixed in a mutually optically aligned state via the joint 50c provided at the center.

FIG. 5 is a perspective view illustrating a state in which the support device 50 is removed from the HMD 200 illustrated in FIG. 4. The first display part 20a includes the first projection optical system 12a and the first combiner 103a in an integrated state, and the second display part 20b includes a second projection optical system 12b and the second combiner 103b in an integrated state. In the first projection optical system 12a, the first combiner 103a is fixed to the barrel 41 by adhesion or the like in an aligned state. The barrel 41 of the first projection optical system 12a has a space for accommodating the first image element 11a, and supports the first image element 11a in a state of being aligned with the projection lens 21 and the like illustrated in FIG. 2. In the second projection optical system 12b, the second combiner 103b is fixed to the barrel 41 by adhesion or the like in an aligned state. The barrel 41 of the second projection optical system 12b has a space for accommodating a second image element 11b, and supports the second image element 11b in a state of being aligned with the projection lens 21 and the like illustrated in FIG. 2. Each barrel 41 is provided with a plurality of fastening units 51f for screwing to the first frame 52a or the second frame 52b illustrated in FIG. 4.

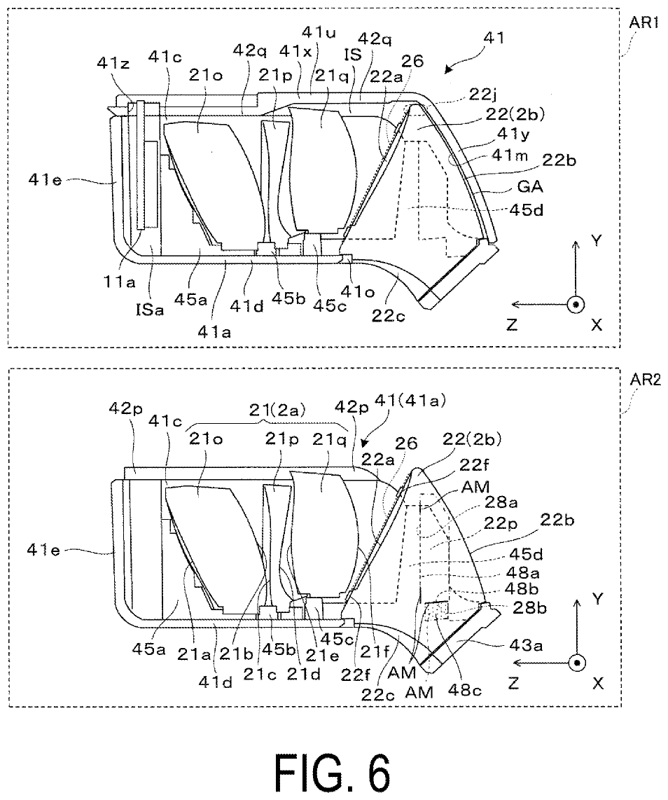

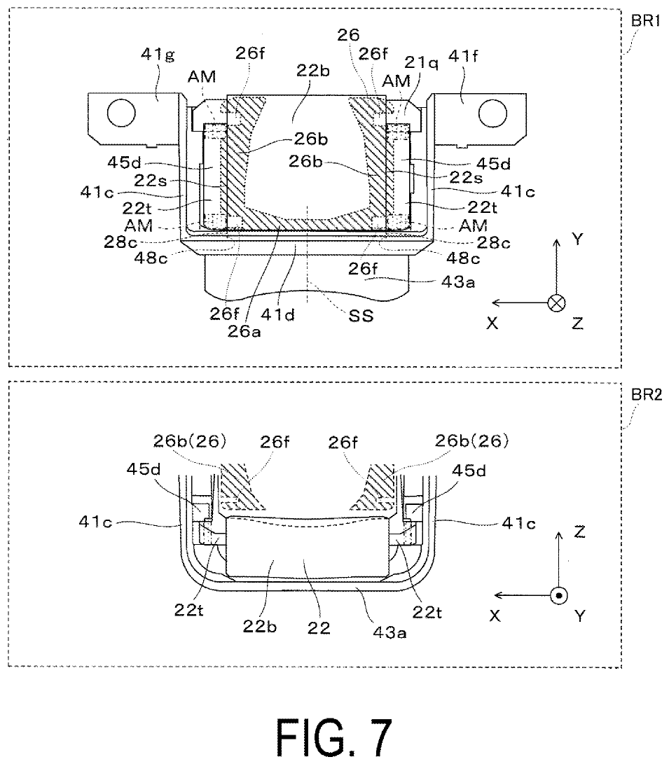

A structure of the barrel 41 is described with reference to FIG. 6 and FIG. 7. In FIG. 6, a region AR1 is a side cross-sectional view of the barrel 41 and the optical members 2a and 2b held by the barrel 41, and a region AR2 is a side cross-sectional view of the remaining portion excluding the barrel cover 41u. Further, in FIG. 7, a region BR1 is a rear view of the remaining portion excluding the barrel cover 41u, and a region BR2 is a plan view of a rear end portion of the remaining portion excluding the barrel cover 41u.

The barrel 41 includes a barrel body 41a and a barrel cover 41u, accommodates the first optical member 2a, and holds the second optical member 2b. The barrel body 41a and the barrel cover 41u are formed of polycarbonate resin in consideration of support accuracy and strength for the optical elements fixed inside. The barrel body 41a is a bathtub-shaped container that is open on the upper side and has the opening 410 at part of the bottom. The barrel cover 41u is fixed so as to cover the barrel body 41a from the upper side. The barrel body 41a includes two side plate members 41c, a bottom plate member 41d, a front plate member 41e, and two protruding portions 41f and 41g. The two side plate members 41c extend substantially parallel to an off-axis plane SS (see FIG. 7) in which the optical axis AX extends and are spaced apart from each other. The bottom plate member 41d extends substantially along an X-Z plane perpendicular to the off-axis plane SS in which the optical axis AX extends, and is provided with the opening 410 on a rear end side. The front plate member 41e couples the front end of the bottom plate member 41d and the front ends of the two side plate members 41c. The two protruding portions 41f and 41g extend in the transverse direction so as to protrude outward from upper portions of the two side plate members 41c.

On the inner side of one side plate member 41c, there are formed stepped guide projection portions 45a, 45b, 45c, and 45d, as projections for supporting the first lens 21o, the second lens 21p, and the third lens 21q, which constitute the first optical member 2a, and the prism mirror 22 of the second optical member 2b. Although not illustrated, guide projection portions similar to the guide projection portions 45a, 45b, 45c, and 45d are formed on the inner surface of the other side plate member 41c (see FIG. 7). The first lens 210 is supported by the barrel body 41a while being aligned so as to be biased toward the two first guide projection portions 45a provided on the inner surfaces of the two side plate members 41c. Similarly, the second lens 21p is supported by the barrel body 41a while being aligned by the second guide projection portions 45b, the third lens 21q is supported by the barrel body 41a while being aligned by the third guide projection portions 45c, and the prism mirror 22 supported by the barrel body 41a while being aligned by the fourth guide projection portions 45d.

The barrel cover 41u is disposed on the opposite side from the bottom plate member 41d and covers the inside of the barrel body 41a to form an accommodation space IS. The barrel cover 41u includes a top plate 41x and a rear plate 41y. The top plate 41x extends in parallel with the X-Z plane, and the rear plate 41y is disposed to be inclined with respect to the X-Z plane and the X-Y plane so as to cover the outside of the reflection surface 22b of the prism mirror 22 of the second optical member 2b. The rear plate 41y has an inner surface 41m extending along and in the vicinity of the reflection surface 22b of the prism mirror 22. A uniform gap GA is formed between the outer side of the reflection surface 22b and the inner surface 41m of the rear plate 41y. The gap GA defines, for example, an interval of about 0.1 mm to 1 mm.

A fitting structure, such as a step, is provided between an outer edge 42q of the barrel cover 41u and an upper end 42p of the barrel body 41a to achieve mutual alignment for example. The gap between the outer edge 42q of the barrel cover 41u and the upper end 42p of the barrel body 41a may be filled with an adhesive or a sealing material. In this case, the airtightness of the accommodation space IS can be enhanced.

In the barrel 41, a diaphragm plate member 26 is disposed between the first optical member 2a and the second optical member 2b. Preferably, the diaphragm plate member 26 is disposed between the first image element 11a and the intermediate image IM, and at or vicinity of a position of an intermediate pupil where the luminous fluxes from respective points on the display surface 11d have the largest diameter. In the illustrated case, the diaphragm plate member 26 is attached adjacent to the incident surface 22a of the prism mirror 22. Referring to FIG. 7, the diaphragm plate member 26 has a central portion 26a disposed in the vicinity of the bottom plate member 41d of the barrel 41, and two side portions 26b extending from the center portion 26a along the two side plate members 41c. In the present embodiment, the optically effective area extends to an upper end portion 22j of the prism mirror 22. Therefore, the diaphragm plate member 26 is an open type having the central portion 26a corresponding to the lower side and the side portions 26b corresponding to the left and right sides with the upper side omitted. Still, it has been confirmed that this configuration does not significantly affect the optical performance. With such a diaphragm plate member 26, the barrel cover 41u can easily arranged close to the upper end portion 22j of the prism mirror 22. As a result, the protrusion amount of the barrel cover 41u can be prevented from increasing, and the barrel 41 can be reduced in size.

Notches 26f are provided at four portions of the periphery of the diaphragm plate member 26. The notches 26f fit with four projections 22f formed on the outer side of the incident surface 22a of the prism mirror 22, that is, a side surface 22s side. Thus, the diaphragm plate member 26 is aligned with respect to the incident surface 22a of the prism mirror 22. The diaphragm plate member 26 is fixed to the projections 22f using adhesive around the notches 26f.

In the barrel 41, in a space ISa facing the front plate member 41e, the first image element 11a is inserted from above through a hole 41z and fixed in an aligned state.

Fixing of the second optical member 2b or the prism mirror 22 in the barrel 41 will be described. The prism mirror 22 includes projections 22t on the pair of side surfaces 22s sandwiched between the incident surface 22a, the reflection surface 22b, and the emitting surface 22c. A pair of first support surfaces 28a of the projection 22t on the incident surface 22a side are in contact with a pair of first placement surfaces 48a provided to the guide projection portions 45d formed on the barrel body 41a. A pair of second support surfaces 28b of the projection 22t on the emitting surface 22c side are in contact with a pair of second placement surfaces 48b provided to the guide projection portions 45d formed on the barrel body 41a. A pair of outward facing third support surfaces 28c provided on the lower side of the projections 22t in the side surfaces 22s are in contact with a pair of inwardly facing third placement surfaces 48c provided to the guide projection portions 45d formed on the barrel body 41a. By means of the contact between the first support surfaces 28a and the first placement surfaces 48a, the prism mirror 22 can be aligned in terms of the position in the Z direction and inclination around the Y axis and the X axis. By means of the contact between the second support surfaces 28b and the second placement surfaces 48b, the prism mirror 22 can be aligned in terms of the position in the Y direction and inclination around the Z axis. By means of the contact between the third support surfaces 28c and the third placement surfaces 48c, the prism mirror 22 can be aligned in terms of the position in the X direction. When the prism mirror 22 is assembled to the barrel body 41a, the barrel body 41a is vertically placed to have the guide projection portions 45d or the opening 410 disposed on the upper side. Thereafter, an adhesive AM is applied to appropriate portions of the first placement surfaces 48a, the second placement surfaces 48b, and the third placement surfaces 48c of the guide projection portions 45d and the prism mirror 22 is inserted like a drawer with the pair of projections 22t placed on the pair of guide projection portions 45d. The prism mirror 22 can be precisely fixed to the barrel body 41a by curing the adhesive AM of each part after the alignment has been completed. As the adhesive AM, for example, UV-curable adhesive can be used, but the adhesive AM is not limited thereto.

While the method of aligning and fixing the prism mirror 22 to the guide projection portions 45d formed on the barrel body 41a is described above, the method of fixing the first lens 21o, the second lens 21p, and the third lens 21q to the first guide projection portions 45a, the second guide projection portions 45b, and the third guide projection portions 45c is also the same as that in the case of the prism mirror 22, and the description thereof will be omitted. As for the order of assembly, first, the first lens 210 is fixed to the barrel body 41a, then the second lens 21p is fixed to the barrel body 41a, then the third lens 21q is fixed to the barrel body 41a, and finally the prism mirror 22 is fixed to the barrel body 41a.

The method of fixing the prism mirror 22 and the like to the barrel body 41a is not limited to the method using the bias described above, but may be replaced with a method using fitting or other various methods.

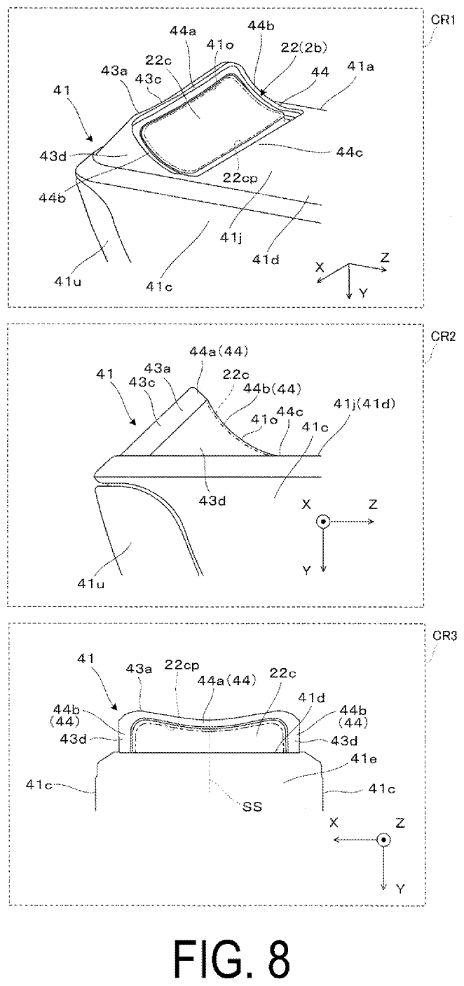

With reference to FIG. 8, the periphery of the opening 410 of the barrel 41 will be described. In FIG. 8, a region CR1 is a perspective view illustrating the periphery of the opening 41o, a region CR2 is a side view illustrating the periphery of the opening 41o, and a region CR3 is a front view illustrating the periphery of the opening 41o. A guard 43a is formed in the periphery of the opening 410 provided on the backward side of the bottom plate member 41d of the barrel 41, to protrude from the bottom portion of the barrel 41. The guard 43a protects the side surface of the prism mirror 22 projecting downward from a main body 41j of the bottom plate member 41d. The guard 43a includes an inclined rear portion 43c and a side portion 43d. The inclined opening 410 is formed that is surrounded by the guard 43a and the main body 41j. The opening 410 is inclined by several tens of degrees in the forward +Z direction with respect to the downward −Y direction. A rectangular annular edge portion 44 provided around the opening 410 is disposed to surround an outer edge 22cp of the emitting surface 22c of the prism mirror 22. The edge portion 44 of the opening 410 includes a portion 44a corresponding to the rear portion 43c of the guard 43a, a portion 44b corresponding to the side portion 43d of the guard side 43a, and a portion 44c corresponding to the main body 41j of the bottom plate member 41d The edge portion 44 provided around the opening 410 surrounds the outer edge 22cp of the emitting surface 22c of the prism mirror 22 from the outside, thereby protecting the emitting surface 22c of the prism mirror 22 from the periphery. The outer edge 22cp of the emitting surface 22c of the prism mirror 22 is disposed recessed and inside and recessed from, that is, more on the inner side than the edge portion 44 of the opening 41o. In other words, the emitting surface 22c of the prism mirror 22 is disposed deeper than the edge portion 44 of the opening 41o. Specifically, the upper end of the outer edge 22cp of the emitting surface 22c of the prism mirror 22 is lower than the upper end of the edge portion 44 of the opening 410 by about 0.1 mm to 1 mm in the +Y direction. Thus, it is possible to unintended object from colliding with the outer edge 22cp of the prism mirror 22 or touching the outer edge 22cp, and to suppress deterioration of the emitting surface 22c. The size of the opening 410 is set to, for example, 6.5 mm×15 mm.

A gap between the outer edge 22cp of the emitting surface 22c of the prism mirror 22 and the edge portion 44 of the opening 410 can be filled with an adhesive or a sealing material. In this case, the airtightness of the accommodation space IS can be enhanced.

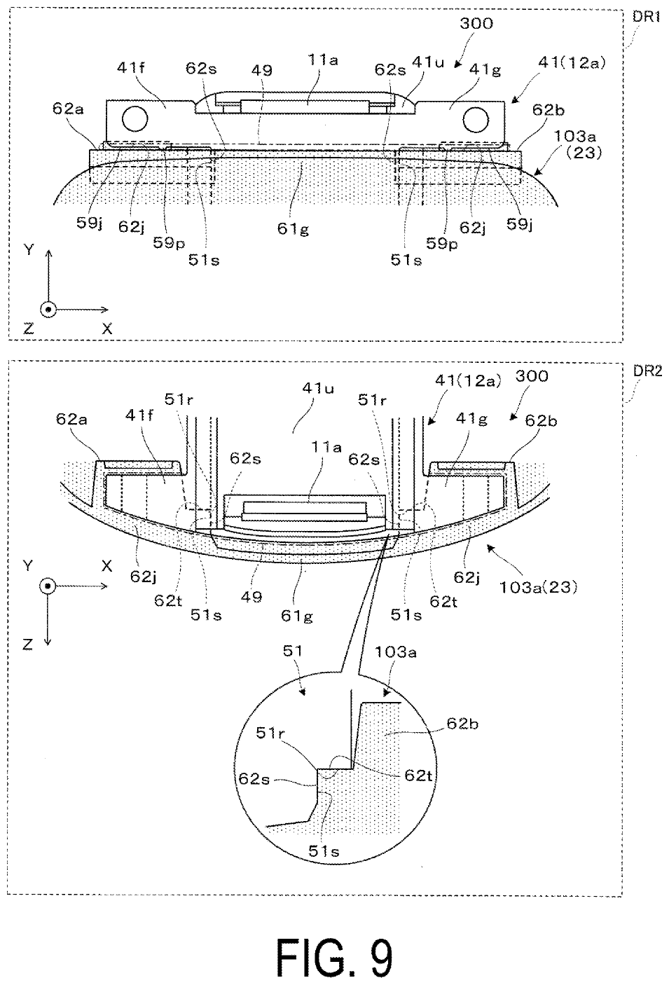

FIG. 9 is a diagram illustrating fixing of the first combiner 103a to the barrel 41, that is, fixing of the see-through mirror 23 to the first projection optical system 12a. In FIG. 9, a region DR1 is a front view of the barrel 41 and the first combiner 103a, and a region DR2 is a plan view of the barrel 41 and the first combiner 103a. An object obtained by assembling the first image element 11a to the first display part 20a that is a combination of the first projection optical system 12a including the barrel 41 and the first combiner 103a fixed to the barrel 41 is referred to as an optical unit 300.

In the optical unit 300, the pair of protruding portions 41f and 41g are formed on the front side of the barrel 41 so as to protrude outward in the transverse direction. A pair of attachment portions 62a and 62b are formed on an upper end 61g of the first combiner 103a so as to protrude inward. A pair of opposed 62s of the pair of attachment portions 62a and 62b are fitted to the pair of outward lateral side surfaces 51s of the barrel 41 so as to sandwich the same, whereby alignment in the ±X directions is performed so as to reduce the inclination. A pair of rear side surfaces 62t of the pair of attachment portions 62a and 62b come into contact with a pair of stepped front side surfaces 51r of the barrel 41, whereby alignment in the ±Z directions is performed so as to reduce the inclination. The plurality of protrusions 59p projecting from a bottom surfaces 59j of the pair of protruding portions 41f and 41g come into contact with a pair of upper surfaces 62j of the pair of attachment portions 62a and 62b, whereby alignment in the ±Y directions is performed. After the above-described alignment, that is, after the alignment of the six axes, an adhesive 49 is supplied between the bottom surfaces 59j of the protruding portions 41f and 41g and the and the upper surfaces 62j of the attachment portions 62a and 62b, and the supplied adhesive 49 is cured by ultraviolet rays or the like, thereby completing the fixing of the first combiner 103a to the barrel 41.

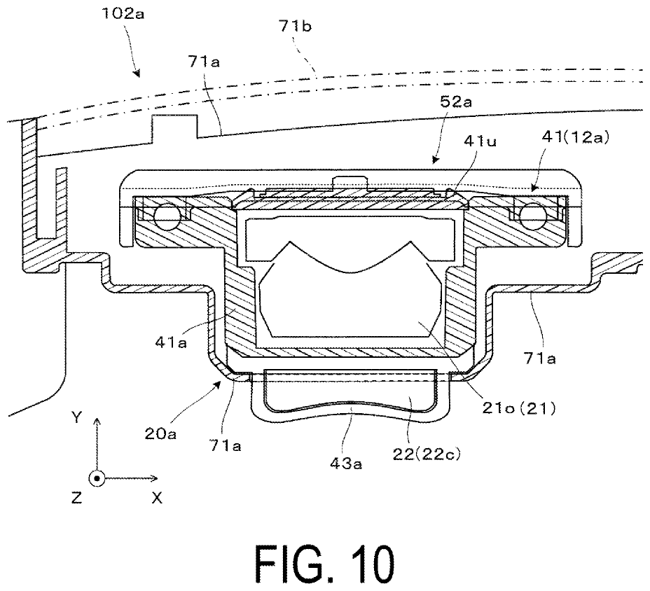

FIG. 10 is a front cross-sectional view of the first display drive part 102a of the first display device 100A illustrated in FIG. 1. The first frame 52a is fixed to the barrel 41. The first frame 52a supports and determines the arrangement of the first display part 20a including the barrel 41. A lower cover 71a is disposed so as to cover the lower side of the barrel 41. The lower cover 71a is supported by the joint 50c and the first frame 52a illustrated in FIG. 4, and is coupled to the support devices 100C illustrated in FIG. 1 at an end portion on the left side in the figure. An upper cover 71b is detachably attached to the lower cover 71a.

An image display device 100 according to the embodiment described above includes: the first image element 11a, the first optical member 2a disposed on a light emission side of the first image element 11a, the second optical member 2b including the incident surface 22a disposed on the light emission side of the first optical member 2a, the reflection surface 22b with which the optical axis AX is bent, and the concaved emitting surface 22c, and the barrel 41 configured to accommodate the first optical member 2a and hold the second optical member 2b, wherein the emitting surface 22c of the second optical member 2b is exposed through the opening 410 of the barrel 41, and the outer edge 22cp of the emitting surface 22c is surrounded by the edge portion 44 of the opening 41o.

In the image display device 100, the emitting surface 22c of the second optical member 2b is exposed through the opening 410 of the barrel 41, and the outer edge 22cp of the emitting surface 22c is surrounded by the edge portion 44 of the opening 41o. Thus, the emitting surface 22c of the second optical member 2b is protected by the edge portion 44 of the opening 410 of the barrel 41 and thus is less likely to be deteriorated by external force.

In the image display device 100 according to the present embodiment, the outer edge 22cp of the emitting surface 22c of the second optical member 2b is disposed to be more retracted that is more on the inner side than the edge portion 44 of the opening 410 of the barrel 41. In this case, the emitting surface 22c of the second optical member 2b is disposed deeper than the edge portion 44 of the opening 41o, whereby the emitting surface 22c of the second optical member 2b is reliably protected.

In the image display device 100 according to the present embodiment, the emitting surface 22c of the second optical member 2b is a concave surface. In this case, the emitting surface 22c of the second optical member 2b is entirely protected by the edge portion 44 of the opening 410 of the barrel 41, whereby the emitting surface 22c of the second optical member 2b is reliably protected.

Modifications and Others

Although the present disclosure has been described with reference to the above embodiments, the present disclosure is not limited to the above embodiments and can be implemented in various modes without departing from the spirit of the disclosure. For example, the following modifications are possible.

While the HMD 200 includes the first display device 100A and the second display device 100B in the above description, the HMD 200 or the image display device 100 may be configured such that one of the first display device 100A and the second display device 100B is supported in front of the eyes by the support device 100C.

While the first frame 52a and the second frame 52b are coupled to each other via the joint 50c in the above description, the first frame 52a and the second frame 52b may be directly coupled to each other, or the first frame 52a, the second frame 52b, and the joint 50c may be integrated into a metallic component.

In the description above, the image display device 100 is assumed to be mounted and used on a head, but the image display device 100 described above may also be used as a hand-held display that is not mounted on a head and is viewed into it like a pair of binoculars. In other words, the head-mounted display also includes a hand-held display in the present disclosure.

An image display device of a specific aspect includes: an image element, a first optical member disposed on a light emission side of the image element, a second optical member including an incident surface disposed on the light emission side of the first optical member, a reflection surface configured to bend an optical axis, and an emitting surface, and a barrel configured to accommodate the first optical member and hold the second optical member, wherein the emitting surface of the second optical member is exposed through an opening of the barrel, and an outer edge of the emitting surface is surrounded by an edge portion of the opening.

In the image display device described above, the emitting surface of the second optical member is exposed through the opening of the barrel, and the outer edge of the emitting surface is surrounded by the edge portion of the opening. Thus, the emitting surface of the second optical member is protected by the edge portion of the opening of the barrel and thus is less likely to be deteriorated by external force.

In the image display device of a specific aspect, the outer edge of the emitting surface of the second optical member is disposed to be more retracted that is more on the inner side than the edge portion of the opening of the barrel. In this case, the emitting surface of the second optical member is disposed deeper than the edge portion of the opening, whereby the emitting surface of the second optical member is reliably protected.

In the image display device of a specific aspect, the emitting surface of the second optical member is a concave surface. In this case, the emitting surface of the second optical member is entirely protected by the edge portion of the opening of the barrel, whereby the emitting surface of the second optical member is reliably protected.

In the image display device of a specific aspect, the barrel includes: a barrel body including two side plate members that extend substantially parallel to a plane in which the optical axis extends and spaced apart from each other, a bottom plate member that extends substantially along a plane perpendicular to the plane in which the optical axis extends and is provided with the opening, and a front plate member coupling front ends of the bottom plate member and the two side plate members, and a barrel cover that is disposed on an opposite side from the bottom plate member and covers an inner side of the barrel body to form an accommodation space. In this case, the first optical member and the second optical member can be easily disposed in the barrel having a container shape.

In the image display device of a specific aspect, the first optical member and the second optical member are aligned in the barrel body so as to be biased toward a guide projection portion projecting inward from the two side plate members. In this case, the first optical member and the second optical member can be placed on the guide projection portion to be held by the barrel body, whereby the first optical member and the second optical member can be easily aligned.

In the image display device of a specific aspect, the barrel cover covers outer side of the reflection surface of the second optical member, and the barrel cover has an inner surface extending along and in vicinity of the reflection surface. In this case, the reflection surface can be protected and prevented from coming into contact with the inner surface of the barrel cover.

The image display device of a specific aspect further includes a diaphragm plate member disposed between the first optical member and the second optical member, wherein the diaphragm plate member includes a central portion disposed in vicinity of the bottom plate member of the barrel and two side portions extending along the two side plate members from the central portion. With this configuration, even when the effective area of the second optical member is disposed in the vicinity of the outer edge on the barrel cover side, excessive light shielding by the diaphragm plate member can be prevented.

In the image display device of a specific aspect, a band-shaped portion extending along a plane perpendicular to the plane in which the optical axis extends in the barrel cover extends between end portions of the pair of side portions of the diaphragm plate member. In this case, the band-shaped portion can function as a part of the diaphragm.

The image display device of a specific aspect further includes a combiner disposed on the light emission side of the second optical member, wherein the combiner is aligned and fixed with respect to a pair of protruding portions extending on outer side of the barrel. In this case, arrangement accuracy of the combiner with respect to the barrel and the second optical member can be improved.

In the image display device of a specific aspect, the barrel is formed of polycarbonate resin.

The image display device of a specific aspect further includes a display control device configured to make the image element perform a display operation.

An optical unit according to an aspect of the present disclosure includes: an image element, a first optical member disposed on a light emission side of the image element, a second optical member including an incident surface disposed on the light emission side of the first optical member, a reflection surface configured to bend an optical axis, and an emitting surface, and a barrel configured to accommodate the first optical member and hold the second optical member, wherein the emitting surface of the second optical member is exposed through an opening of the barrel, and an outer edge of the emitting surface is surrounded by an edge portion of the opening.

What is claimed is:

1. An image display device, comprising:
an image element;
a first optical member disposed on a light emission side of the image element;
a second optical member including an incident surface disposed on a light emission side of the first optical member, a reflection surface configured to bend an optical axis, and an emitting surface; and
a barrel configured to accommodate the first optical member and hold the second optical member, wherein
the emitting surface of the second optical member is exposed through an opening of the barrel, and an outer edge of the emitting surface is surrounded by an edge portion of the opening.

2. The image display device according to claim 1, wherein the outer edge of the emitting surface of the second optical member is disposed inside and recessed from the edge portion of the opening of the barrel.

3. The image display device according to claim 1, wherein the emitting surface of the second optical member is a concave surface.

4. An image display device, comprising:
an image element;
a first optical member disposed on a light emission side of the image element;
a second optical member including an incident surface disposed on a light emission side of the first optical member, a reflection surface configured to bend an optical axis, and an emitting surface; and
a barrel configured to accommodate the first optical member and hold the second optical member, wherein
an outer edge of the emitting surface of the second optical member is disposed inside and recessed from an edge portion of an opening of the barrel.

5. An image display device, comprising:
an image element;
a first optical member disposed on a light emission side of the image element;
a second optical member including an incident surface disposed on a light emission side of the first optical member, a reflection surface configured to bend an optical axis, and an emitting surface; and
a barrel configured to accommodate the first optical member and hold the second optical member, wherein
the emitting surface of the second optical member is exposed through an opening of the barrel, and the emitting surface of the second optical member is a concaved surface.

6. The image display device according to claim 1, wherein the barrel includes:
a barrel body including
two side plate members that extend substantially parallel to a plane in which the optical axis extends, the two side plate members being spaced apart from each other,
a bottom plate member that extends substantially along a plane perpendicular to the plane in which the optical axis extends, the bottom plate being provided with the opening, and
a front plate member coupling front ends of the bottom plate member and the two side plate members; and
a barrel cover that is disposed on an opposite side from the bottom plate member and covers an inner side of the barrel body to form an accommodation space.

7. The image display device according to claim 6, wherein the first optical member and the second optical member are aligned in the barrel body so as to be biased toward a guide projection portion projecting inward from the two side plate members.

8. The image display device according to claim 6, wherein
the barrel cover covers an outer side of the reflection surface of the second optical member, and
the barrel cover has an inner surface extending along the reflection surface to a vicinity of the reflection surface.

9. The image display device according to claim 1 comprising a diaphragm plate member disposed between the first optical member and the second optical member, wherein
the diaphragm plate member includes a central portion disposed in a vicinity of the bottom plate member of the barrel, and two side portions extending along the two side plate members from the central portion.

10. The image display device according to claim 1 comprising a combiner disposed on a light emission side of the second optical member, wherein
the combiner is aligned with respect to and fixed to a pair of protruding portions extending on an outer side of the barrel.

11. The image display device according to claim 1, wherein the barrel is formed of polycarbonate resin.

12. The image display device according to claim 1, further comprising a display control device configured to cause the image element to perform a display operation.

13. An optical unit, comprising:
an image element;
a first optical member disposed on a light emission side of the image element;
a second optical member including an incident surface disposed on a light emission side of the first optical member, a reflection surface configured to bend an optical axis, and an emitting surface; and
a barrel configured to accommodate the first optical member and hold the second optical member, wherein
the emitting surface of the second optical member is exposed through an opening of the barrel, and an outer edge of the emitting surface is surrounded by an edge portion of the opening.
